(19) United States
(12) Patent Application Publication
(10) Pub. No.: US 2022/0414503 A1
(43) Pub. Date: Dec. 29, 2022

(54) SLO-AWARE ARTIFICIAL INTELLIGENCE INFERENCE SCHEDULER FOR HETEROGENEOUS PROCESSORS IN EDGE PLATFORMS

(71) Applicant: Korea Advanced Institute of Science and Technology, Daejeon (KR)

(72) Inventors: Jongse PARK, Daejeon (KR); Wonik SEO, Daejeon (KR); Sanghoon CHA, Daejeon (KR); Yeonjae KIM, Daejeon (KR); Jaehyuk HUH, Daejeon (KR)

(21) Appl. No.: 17/569,393

(22) Filed: Jan. 5, 2022

(30) Foreign Application Priority Data
Jun. 23, 2021 (KR) 10-2021-0081242

(51) Int. Cl. G06N 5/04; G06F 9/48

(52) U.S. Cl. CPC G06N 5/046; G06F 9/4881

(57) ABSTRACT

Disclosed is an SLO-aware artificial intelligence inference scheduler technology in a heterogeneous processor-based edge system. A scheduling method for a machine learning (ML) inference task, which is performed by a scheduling system, may include receiving inference task requests of multiple ML models with respect to an edge system composed of heterogeneous processors and operating heterogeneous processor resources of the edge system based on a service-level objective (SLO)-aware-based scheduling policy in response to the received inference task requests.

### CROSS-REFERENCES TO RELATED APPLICATIONS

This application is based on and claims priority under 35 U.S.C. 119 to Korean Patent Application No. 10-2021-0081242, filed on Jun. 23, 2021 in the Korean intellectual property office, the disclosure of which is herein incorporated by reference in its entirety.

### TECHNICAL FIELD

The following description relates to a method and system for scheduling an inference task of a machine learning model in an edge system.

### BACKGROUND OF THE DISCLOSURE

In recent years, as machine learning (ML) algorithms are remarkably advanced, many problems can be solved with human-level accuracies. Based on such excellent advances, the trend is to integrate the ML algorithms into various types of actual applications and distribute applications to edge platforms.

Edge platforms often serve for multiple purposes and have to handle different types of inference requests for different ML models at the same time. A situation in which inference requests have to be simultaneously processed seems to be intensified because the number of computed-enabled edge platforms that can directly interact with humans needs to be limited, and ML algorithms are being permeated into virtually every application domain.

Conventionally, multiple ML models inference operation is disposed on a single processor edge system or a single machine learning model inference operation is disposed on a heterogeneous processor edge system. However, a problem in that various machine learning inference operations are disposed on heterogeneous processors of edge systems has not been solved.

In particular, if inference task requests of various models are inputted to an edge system, to achieve a service-level objective (SLO) is essential for a practical edge system operation, but a task scheduler that enables the achievement is not present.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Embodiments may provide a scheduling method and system for heterogeneous processors and heterogeneous ML models by taking into consideration various characteristics of various ML models in various types of processors.

Embodiments may provide an SLO-aware inference scheduling method and system based on expected latency by using a pre-profiled task behavior.

Embodiments may provide a model slicing technology that provides rough preemption for GPU and DSP calculation and a method and system for solving a resource blocking problem based on a big ML task that may lead to SLO violation of a next task.

In various embodiments, a scheduling method for a machine learning (ML) inference task, which is performed by a scheduling system, may include receiving inference task requests of multiple ML models with respect to an edge system composed of heterogeneous processors, and operating heterogeneous processor resources of the edge system based on a service-level objective (SLO)-aware-based scheduling policy in response to the received inference task requests.

The SLO-aware-based scheduling policy may include any one of a scheduling policy through minimum average-expected latency (MAEL), a scheduling policy through SLO-aware-based MAEL or a scheduling policy through SLO-aware-based MAEL preemption.

Operating the heterogeneous processor resources may include configuring the scheduling policy through MAEL in order to minimize an average turnaround time of all the inference tasks requested and accumulated during a given scheduling time-window as latency for an inference task of an ML model expected at a scheduling point is predicted.

Operating the heterogeneous processor resources may include collecting a candidate set in which a given inference task at a specific point in a runtime, which is periodically invoked, and a processor available in the edge system are mapped, and calculating a per-candidate score for the candidate set by repeating a process of collecting the collected candidate set.

Operating the heterogeneous processor resources may include estimating expected latency, which is a sum of latency of a profiled task in the available processor in order to calculate the per-candidate score and a current wait time attributable to a task whose scheduling is already pending, and accumulating all the tasks in which the estimated expected latencies are set in an inverse order in order to designate priority of a candidate that provides minimum-expected latency.

Operating the heterogeneous processor resources may include determining a candidate that generates MAEL among the candidate set in which the inference task and the processor available in the edge system are mapped based on the calculated per-candidate score, and assigning an inference task, included in the determined candidate, to a processor included in the determined candidate.

Operating the heterogeneous processor resources may include sequentially accumulating scheduled tasks based on past schedule information according to a request priority queue present in the processor, and inserting the inference task between tasks pending in the request priority queue in a way to minimize average-expected latency.

Operating the heterogeneous processor resources may include configuring a scheduling policy through SLO-aware-based MAEL in order to minimize a total sum of SLO violation levels as an SLO violation is expected to occur by taking system throughput into consideration after minimizing avoidance of the SLO violation.

Operating the heterogeneous processor resources may include collecting a candidate set in which an inference task and a processor available in the edge system are mapped based on SLO requirements for each task, and calculating a per-candidate score for the candidate set by repeating a process of collecting the collected candidate set.

Operating the heterogeneous processor resources may include calculating average-expected latency and a score for the SLO, checking whether the expected latency is greater than a required SLO before calculating the score, calculating SLO violation degrees instead of calculating expected latency because the task is expected to violate the SLO when the expected latency is greater than the required SLO, and accumulating negative values of the calculation SLO violation degrees.

Operating the heterogeneous processor resources may include determining a candidate having a score having a preset reference or higher based on the calculated per-candidate score, and assigning an inference task, included in the determined candidate, to a processor included in the determined candidate.

Operating the heterogeneous processor resources may include configuring a scheduling policy through SLO-aware-based MAEL preemption using a model slicing scheme that achieves a preemption effect for a scheduling goal by splitting an ML model into evenly-sized sub-ML models by using properties of the ML model composed of a plurality of layers and achieving and filling sub-tasks for each split sub-ML model.

Operating the heterogeneous processor resources may include checking whether model slicing is enabled or disabled, splitting the inference task into a set of sliced sub-tasks while removing the inference task from the task set in order to prevent a calculation of redundant tasks when the model slicing is enabled, and inserting the sliced sub-tasks into the task set.

Operating the heterogeneous processor resources may include determining whether a designated task is expected to violate SLO requirements due to a pending latency task when a slice mode is disabled while inserting the sliced sub-tasks into the request priority queue, enabling the slice mode when the designated task is expected to violate the SLO requirements due to the pending latency task, and disabling the slice mode when the designated task is expected to not violate the SLO requirements due to the pending latency task.

Operating the heterogeneous processor resources may include checking whether sliced pieces of the slice mode help eliminating potential SLO violations when the slice mode is already enabled, maintaining the slice mode in the enable state when determining that the sliced pieces of the slice mode help eliminating the potential SLO violation, and disabling the slice mode when determining that the sliced pieces of the slice mode do not help eliminating the potential SLO violation.

In a computer program stored in a computer-readable recording medium in order to execute a scheduling method for a machine learning (ML) inference task, which is performed by a scheduling system, the scheduling method may include receiving inference task requests of multiple ML models with respect to an edge system composed of heterogeneous processors, and operating heterogeneous processor resources of the edge system based on a service-level objective (SLO)-aware-based scheduling policy in response to the received inference task requests.

A scheduling system may include a task request reception unit configured to receive inference task requests of multiple ML models with respect to an edge system composed of heterogeneous processors, and a resource operation unit configured to operate heterogeneous processor resources of the edge system based on a service-level objective (SLO)-aware-based scheduling policy in response to the received inference task requests.

The resource operation unit may configure the scheduling policy through MAEL in order to minimize an average turnaround time of all the inference tasks requested and accumulated during a given scheduling time-window as latency for an inference task of an ML model expected at a scheduling point is predicted.

The resource operation unit may configure a scheduling policy through SLO-aware-based MAEL in order to minimize a total sum of SLO violation levels as an SLO violation is expected to occur by taking system throughput into consideration after minimizing avoidance of the SLO violation.

The resource operation unit may configure a scheduling policy through SLO-aware-based MAEL preemption using a model slicing scheme that achieves a preemption effect for a scheduling goal by splitting an ML model into evenly-sized sub-ML models by using properties of the ML model composed of a plurality of layers and achieving and filling sub-tasks for each split sub-ML model.

Expected latency that needs to be satisfied with respect to a given inference request at scheduling timing can be scheduled to be minimized. Accordingly, when expected latency is greater than an SLO, an edge system can be efficiently operated by selecting system performance throughput in a way to be compromised at the very least and to satisfy the SLO.

A resource blocking problem attributable to a big ML model task which may lead to SLO violation of a next task can be solved.

Although the variety of an ML model is increased and an inference operation workload is increased in the future, the economic feasibility and profitability of the edge system development industry can be improved through a scheduling scheme that enables resources of given heterogeneous processors to be more efficiently used in an edge system.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is an example illustrating ML inference for various ML model tasks in a heterogeneous platform edge apparatus in an embodiment.

FIG. 2 is a diagram for describing a scheduling operation in an embodiment.

FIG. 3 is a diagram for describing a scheduling operation through minimum-average latency in an embodiment.

FIG. 4 is a diagram for describing a scheduling operation through SLO-aware-based MAEL in an embodiment.

FIG. 5 is a diagram for describing a scheduling operation through SLO-aware-based MAEL preemption in an embodiment.

FIG. 6 is a block diagram for describing a configuration of a scheduling system in an embodiment.

FIG. 7 is a flowchart for describing a scheduling method for an ML inference task in an embodiment.

### DETAILED DESCRIPTION

While illustrative embodiments have been illustrated and described, it will be appreciated that various changes can be made therein without departing from the spirit and scope of the disclosure.

Hereinafter, embodiments are described in detail with reference to the accompanying drawings.

In embodiments, a scheduling method and system for preventing service-level objective (SLO) violation while maximizing system performance throughput by completely efficiently using resources of available heterogeneous processors on an edge system with respect to continuous inference requests for various models are described.

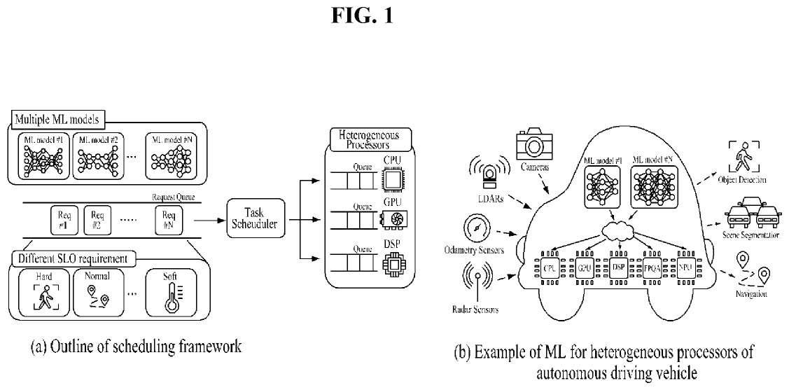

FIG. 1 is an example illustrating machine learning (ML) inference for various ML model tasks in a heterogeneous platform edge apparatus in an embodiment.

FIG. 1(a) is an outline of a scheduling framework. FIG. 1(b) is an example of a machine learning (ML) inference task for heterogeneous processors of an autonomous driving vehicle.

Referring to FIG. 1(a), task scheduling mechanisms for multi-model ML inference tasks may be explored on edge devices. Schedulers may dispatch various types of ML inference tasks to heterogeneous hardware platforms.

FIG. 1(b) illustrates an autonomous driving vehicle, which collects various types of sensory data, performs various types of ML inferences, and performs multiple applications at runtime. In this case, the autonomous driving vehicle is an edge platform that requires computing capabilities in order to perform ML inferences. An autonomous driving vehicle is not the only edge platform to host two or more ML applications. For example, examples of the edge platform include smart-home hubs, fog computing devices, ICU patient monitors, manufacturing robots, surveillance cameras, etc.

In general, unlike the existing embedded devices that usually have a sole purpose or the limited number of features, modern edge platforms often support various capabilities from a wide range of application domains. As different applications need different types of operations and are used in unique contexts, the applications have disparate requirements in terms of performance and energy efficiency. To meet the diversified demands, many edge platforms may be equipped with heterogeneous processors.

As illustrated in FIG. 1(b), an autonomous driving vehicle receives various kinds of sensory data as input and performs inference for various ML models while running on a battery, and thus requires a very high-performance and power-efficient system equipped with heterogeneous platforms, such as a CPU, a GPU, a DSP, an FPGA, and an NPU. For example, a real-world Tesla FSD computer may consist of 3 quad-core CPUs, 1 GPU, 2 NPUs, 1 ISP, and some ASIC chips.

An SLO for ML inference is described. Applications commonly deployed on edge platforms may be provided along with service-level objectives (SLO). When these applications rely on ML algorithms, achieving controlled latencies from ML inference tasks is important in the perspective of an application SLO because an inference processing time usually takes a significant portion of end-to-end application runtime. Achieving the SLO is particularly challenging in the case of edge platforms compared to cloud because an available hardware resource in a system is physically limited and not elastically scalable. Furthermore, ML inference tasks on an edge platform are often a part of mission-critical applications (e.g., pedestrian detection in ADAS), and thus makes an SLO not just a general guideline, but a must condition. The problem becomes more difficult when the edge platforms process various ML inference requests at an arbitrary rate on heterogeneous hardware platforms. An embodiment aims to explore several scheduling policies for multi-model ML inference tasks, while navigating the trade-off space of an average response time, system throughput, and an SLO.

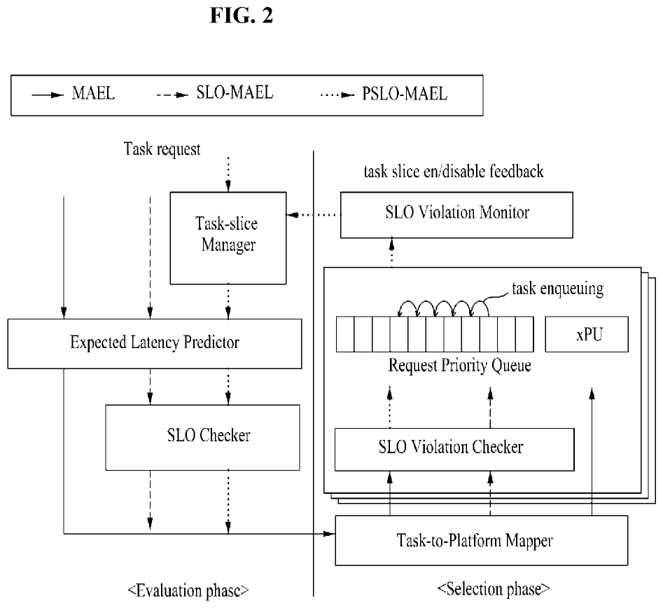

FIG. 2 is a diagram for describing a scheduling operation in an embodiment.

A scheduling system (=scheduler) may determine scheduling for referring to a pre-profiled execution operation of each ML model and minimizing a latency in different computing processors. Scheduling may mean that a schedule for an inference task of a ML model is determined.

For example, processor affinities are different for each ML model depending on factors for each of various models, such as the number of computing tasks, a model size, a layer configuration, and a network topology. ML models have different performance characteristics in terms of processor affinities, but the models may have similar energy efficiency characteristic regardless of their algorithmic properties. Such results imply that in the perspective of schedulers, mapping all given inference tasks to an energy-efficient processor may be suboptimal in terms of performance, but is likely to be the best scheduling determination for energy-efficiency. Accordingly, a scheduling system may design scheduling policies by using the properties of a pair of an ML model and a processor.

A scheduling system may introduce a plurality of scheduling policies. For example, the scheduling system may introduce three scheduling policies. Each policy has a different optimization object, and may be started at a reference scheduling policy optimized to minimize an inference switching time. In this case, two types of SLO-aware scheduling may be designed to satisfy requirements for the SLO.

FIG. 2 visually illustrates three scheduling operations. Different types of arrows illustrate workflows of the proposed three task scheduling operations. xPU illustrates heterogeneous processors of an edge system, such as a CPU, a GPU, and a DSP.

A scheduling system may include any one of a scheduling policy through minimum-average-expected latency (MAEL), a scheduling policy through SLO-aware-based MAEL or a scheduling policy through SLO-aware-based MAEL preemption.

The scheduling policy through MAEL is described below, and is a baseline scheduling policy and a time-window-based scheduling policy not restricted by an SLO. A goal of the scheduling policy through MAEL is to minimize an average turnaround time of all inference tasks, requested and accumulated during a given scheduling window, by predicting their expected inference latencies at a scheduling point. For prediction, this embodiment relies on the unique property of ML models where inference latency for a given ML on a particular processor exhibits a very limited variance and is therefore very predictable. A scheduler collects profile information mapped from a pair of (an ML and a processor) to associated latency offline, and may calculate expected latencies by using the profile information collected at runtime. Since the target system aims to schedule multi-model inference tasks on heterogeneous processors, it is impossible for a runtime scheduler to visit all possible scenarios of task insertions on a per-processor request queue because a search space of scheduling determinations is huge.

Accordingly, the scheduling policy through MAEL may include an evaluation phase for determining on which processor each inference task should be located and a selection phase for determining where a task should be located within a per-processor request queue.

The scheduling policy through SLO-aware-based MAEL is described. Since the scheduling policy through MAEL lacks SLO awareness, even though there are urgent inference tasks requested in a scheduling window, the urgency and schedules are dismissed based on average expected latency. In order to overcome this limitation, a main goal of the scheduling policy through SLO-aware-based MAEL is to take the avoidance and minimization of SLO violations at the first priority and to put system throughput at the next priority.

A goal of the scheduling policy through SLO-aware-based MAEL is to evaluate whether SLO violations are expected to exist, to fall back to the scheduling policy through MAEL if the SLO violations are not expected to arise, and to minimize the total sum of SLO violation degrees if the SLO violations are expected to arise. In this case, the scheduling policy through SLO-aware-based MAEL is related to the SLO violation degrees, not a violation rate (i.e., an inference ratio that violates a given SLO) for the scheduling policy, and tries to not only reduce the SLO violation rate, but also eliminate potential starvation issues. The scheduling policy through SLO-aware-based MAEL has been derived to always prioritize scheduling small tasks over long tasks so that the SLO violation rate is minimized. This is intuitive because saving the many by sacrificing the few is indeed superior in terms of rate, which instead harms the fairness between the scheduled models. In order to provide the inter-model fairness in the system, an insight is sought from a rather conventional scheduling mechanism in operating systems, aging, and leverage the idea in our scheduling scheme by using the SLO violations degrees. As time passes, the starved tasks will be expected to have an increasing degree of violation, so that priority needs to be set in scheduling.

The scheduling policy through SLO-aware-based MAEL preemption is described. The scheduling policy through SLO-aware-based MAEL preemption transmits inference tasks in a non-preemptive way if the balance between system throughput (i.e., the inverse of an average inference turnaround time) and SLO is struck. In certain cases, scheduling capabilities of the scheduling policy through SLO-aware-based MAEL preemption is greatly limited. For example, a few long tasks already occupy all hardware platforms (processors) and are expected to complete computation in quite a while, the hands of the scheduling policy through MAEL are tied. This will in turn engender significant SLO violation in terms of both rate and degree.

In order to address a large SLO violation problem, an inherent algorithmic property of ML models consisting of multiple layers of which computations may be represented as a series of inference tasks may be used. To this end, there may be proposed the scheduling policy SLO-aware-based MAEL preemption using model slicing techniques for splitting large models into smaller yet evenly-sized sub-models and populating a sub-task per a split sub-model to achieve a preemption effect for a scheduling purpose. Overhead associated with model slicing initiates multiple small inference runs instead of single large inference execution. Accordingly, the scheduling policy through SLO-aware-based MAEL preemption is not always active and instead may be turned on when a reduction in SLO violation degrees due to the preemption is expected to be significantly larger than the overhead.

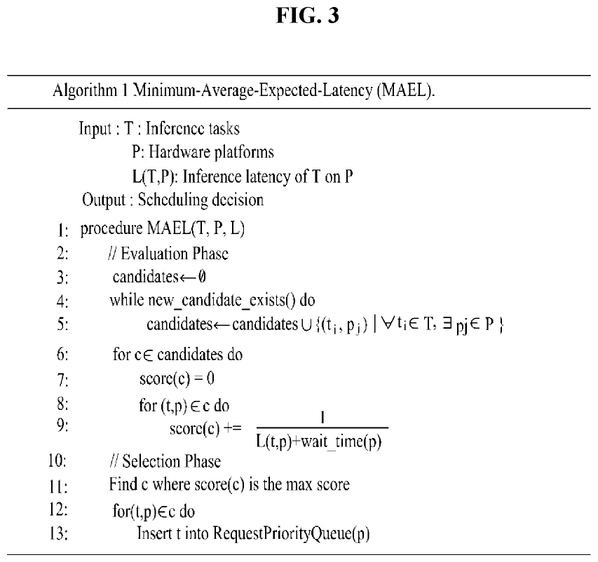

FIG. 3 is a diagram for describing a scheduling operation through minimum-average latency in an embodiment.

FIG. 3 is an algorithm (first algorithm) for describing a scheduling operation through minimum-average latency. In the first algorithm, three sets of input data may be used.

(1) T means a set of inference tasks given to a scheduler at a certain point in the runtime, which is periodically invoked. A scheduling window is a configurable parameter, which is empirically determined;

(2) P means a set of processors available on a given edge platform. Modern edge platforms are increasingly equipped with various sets of hardware processors, such as various accelerators such as a GPU, a DSP, and an NPU, in addition to the existing processors such as a CPU.

(3) L(T, P) means a mapping set from an (inference task, hardware platform) pair to a related latency. Inference latency is heavily dependent on the algorithmic property of model and computing capabilities of hardware platforms, which are deterministic and makes the accurate latency prediction possible. As described above, profile information is collected in priori though offline profiling, and a runtime scheduler simply looks up a mapping table to get latency. The output of the algorithm is scheduling determinations, including a mapped hardware platform and a scheduled location in a request queue.

In an evaluation phase, all possible task-to-platform mappings may be first found and collected a candidate set (Line 5). Then, per-candidate scores may be calculated by iterating over the candidates (Line 6 to 9). In order to calculate the per-candidate scores, expected latency, which is the sum of (1) profiled latency of a task t on a platform p and (2) a current wait time due to pending tasks attributable to already scheduled tasks, may be estimated (Line 9). Since a candidate that delivers the minimum expected latency is to be prioritized, calculated expected latency may be set, and may be accumulated for all tasks. After the evaluation phase, a per-candidate score, score(c), may be obtained, which may be in turn used in a selection phase.

In the selection phase, the collected scores may be swept over, and which task-to-platform mapping produces the minimum average expected latency may be checked (Line 11). Once mappings are determined, the task may be assigned to each platform (Line 13). Each platform has a request priority queue. Such a request priority queue may stack up the scheduled tasks in an order based on past scheduling determinations. The scheduled task t may be inserted in a place between the pending tasks in the request priority queue in such a way that the average expected latency is minimized. In this way, the proposed two-phase scheduling mechanism can effectively reduce the cost of search space exploration.

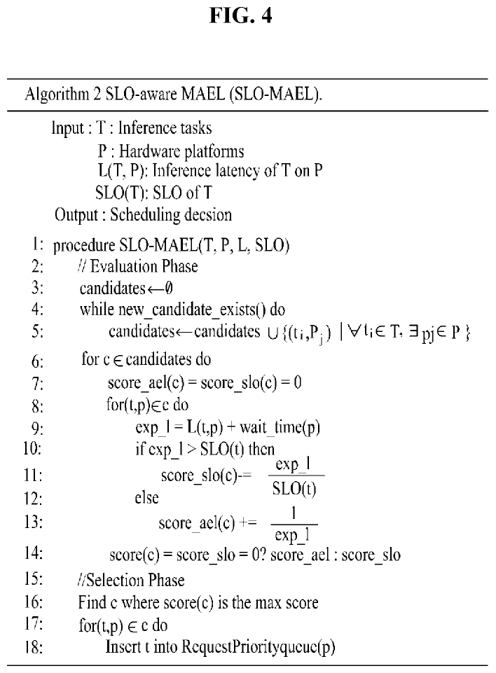

FIG. 4 is a diagram for describing a scheduling operation through SLO-aware-based MAEL in an embodiment.

FIG. 4 is an algorithm (second algorithm) for describing a scheduling operation through minimum-average latency. The second algorithm is am SLO-MAEL (SLO-Aware MAEL) scheduling algorithm constructed based on a minimum-average latency algorithm, and may be designed to track an SLO, that is, another objective. Four sets of input data may be used in the second algorithm.

(1) T means a set of inference tasks given to a scheduler at a certain point in the runtime, which is periodically invoked. A scheduling window is a configurable parameter, which is empirically determined;

(2) P means a set of processors available on a given edge platform. Modern edge platforms are increasingly equipped with various sets of hardware processors, such as various accelerators such as a GPU, a DSP, and an NPU, in addition to the existing processors such as a CPU.

(3) L(T, P) means a mapping set from an (inference task, hardware platform) pair to a related latency. Inference latency is heavily dependent on the algorithmic property of model and computing capabilities of hardware platforms, which are deterministic and makes the accurate latency prediction possible. As described above, profile information is collected in priori though offline profiling, and a runtime scheduler simply looks up a mapping table to get latency. The output of the algorithm is scheduling determinations, including a mapped hardware platform and a scheduled location in a request queue.

(4) SLO(T) means requirements for an SLO for each task.

Basically, the score-based priority scheduling method is identical to the method of the MAEL algorithm. However, at the evaluation phase, two independent scores, that is, score_ael and score_slo, which represent scores for average expected latency and SLO, respectively, may be calculated. Before calculating the scores, the scheduler first may check whether expected latency is larger than a required SLO (Line 10). If the expected latency is larger than the required SLO (YES), this means a task is expected to violate the SLO, and may calculate SLO violation degrees, instead of calculating the expected latency. The degrees of SLO violation may be calculated by normalizing the expected latency based on SLO requirements. Thereafter, negated values of the SLO violation degrees may be accumulated (Line 11). In this way, if there is at least one SLO violation among to-be-scheduled tasks, the score_slo may include a negative value. In the selection phase, a scheduling determination can be simply made because the score is designed in such a way that the larger score value a candidate has, the better scheduling determination the candidate is.

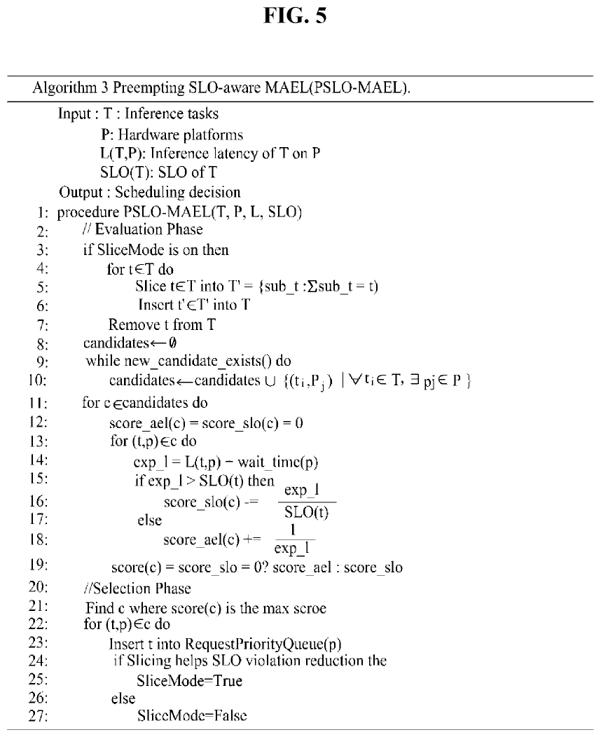

FIG. 5 is a diagram for describing a scheduling operation through SLO-aware-based MAEL preemption in an embodiment.

FIG. 5 is an algorithm (third algorithm) for describing a scheduling operation through SLO-aware-based MAEL preemption. The third algorithm can efficiently enable the preemption even on non-preemption hardware and software inference frameworks by using model slicing in order to further reduce SLO violations. The input and output of the third algorithm are the same as those of the SLO-aware-based MAEL algorithm.

However, unlike the aforementioned algorithms, the scheduling algorithm through SLO-aware-based MAEL preemption maintains a stateful storage variable SliceMode, that is, a flag switch that enables and disables model slicing. In order to set the flag on or off, the scheduler may monitor how beneficial the model slicing is to reduce adverse effects of SLO violations and may prudently determine to turn on/off. The reason why the third algorithm is selected as state storage is that the scheduler needs to speculatively turn on the slicing so that already sliced small tasks can prevent potential SLO violations of unseen large tasks.

Model slicing is helpful when “short” incoming tasks preempt “long” already-scheduled tasks. Moreover, the model slicing comes with a significant amount of latency overhead. Accordingly, turning on model slicing without obtaining a SLO violation reduction only imposes performance degradation, which can be avoided via a speculative model slicing mechanism.

In the evaluation phase, a conditional block that checks whether the model slicing is on is present (Line 3 to 7). If the model slicing is on (YES), the scheduler may slice an inference task (t) into a set (T′) of sliced sub-tasks (sub_t) and put all the sub tasks into the task set (T), while removing the original large task (t) from the task set (T) in order to prevent computing duplicated tasks (Line 5 to 6). Not all of the models are subject to be sliced, and only a large task having a preset size or more may be sliced. A threshold for determining whether to slice is empirically selected, and a slicing mechanism tends to produce evenly-balanced sub tasks so that scheduling using the sub tasks is more manageable. For brevity in the third algorithm, the above details may be omitted in relation to how the scheduler selects the slicing-target models.

The rest of the evaluation phase does not need to be updated because the slicing replaces large tasks with functionally identical sub tasks in the set of inference-requested tasks. Accordingly, an optimized scheduling determination can be smoothly identified.

In the selection phase, there is a slight difference in the process of updating the slice mode flag (Line 24 to 27). While the task is inserted into its request priority queue, if the slice mode is off, whether a given task is expected to violate SLO requirements due to pending long-latency tasks may be checked. If the condition is met, the slice mode may be turned on, and if not, the slice mode remains switched off. In other words, if a designated task is expected to violate the SLO requirements due to the pending long-latency tasks, the slice mode may be on. If the designated task is expected to not violate the SLO requirements, the slice mode may remain turned off. If the slice mode has already been enabled, whether sliced pieces of the slice model help eliminating potential SLO violations may be checked. If it is determined that the sliced pieces of the slice model help eliminating the potential SLO violations (YES), the slice mode remains True. If it is determined that the sliced pieces of the slice model not help eliminating the potential SLO violations, the slice model may be turned off. In this case, the scheduler may ensure the dependencies among the sliced sub-tasks by halting the dispatch of following sub-tasks until the executions of dependent sub-tasks are completed.

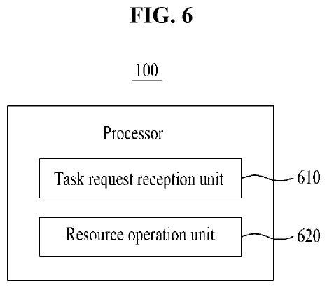

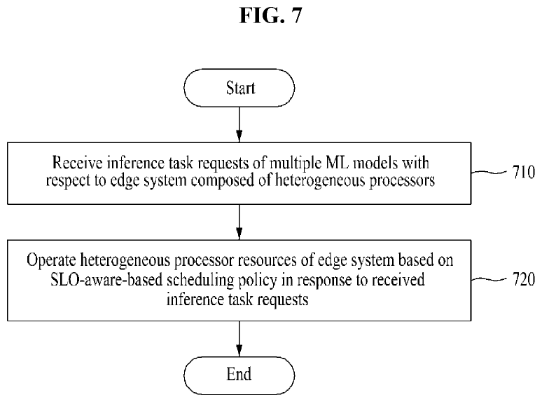

FIG. 6 is a block diagram for describing a configuration of a scheduling system in an embodiment. FIG. 7 is a flowchart for describing a scheduling method for an ML inference task in an embodiment.

A processor of a scheduling system 100 may include a task request reception unit 610 and a resource operation unit 620. The task request reception unit 610 and the resource operation unit 620 may be expressions of different functions performed by the processor based on a control command provided by a program code stored in the scheduling system of the processor. The processor and the elements of the processor may control the scheduling system to perform steps 710 to 720 of FIG. 7, which are included in the scheduling method for an ML inference task. In this case, the processor and the elements of the processor may be implemented to execute a code of an operating system included in a memory and instructions according to a code of at least one program.

The processor may load, into the memory, a program code stored in a file of a program for the scheduling method for an ML inference task. For example, when the program is executed in the scheduling system, the processor may control the scheduling system to load a program code from a file of the program onto the memory under the control of the operating system. In this case, the task request reception unit 610 and the resource operation unit 620 may be different functions of the processor for executing steps 710 to 720 after executing instructions of corresponding portions of the program code loaded onto the memory.

In step 710, the task request reception unit 610 may receive inference task requests of multiple ML models with respect to an edge system composed of heterogeneous processors. The task request reception unit 610 may continuously receive the inference task requests of the multiple ML models with respect to the edge system composed of heterogeneous processors.

In step 720, the resource operation unit 620 may operate heterogeneous processor resources of the edge system based on an SLO-aware-based scheduling policy in response to the received inference task requests. For example, the resource operation unit 620 may configure the scheduling policy through MAEL in order to minimize an average turnaround time of all the inference tasks requested and accumulated during a the given scheduling time-window as latency of the inference tasks of the ML models, which is expected at a scheduling point. The resource operation unit 620 may map an inference task given at a specific point in the runtime, which is periodically invoked, to a processor available in the edge system, may collect a candidate set, and may calculate a per-candidate score for the candidate set by repeating the process of collecting the collected candidate set. The resource operation unit 620 may estimate expected latency, that is, the sum of latency of a profiled task in the available processor and a current wait time attributable to a task whose scheduling is already pending in order to calculate the per-candidate score, and may accumulate all the tasks whose estimated expected latencies have been set in an inverse order in order to designate the priority of a candidate that provides minimum-expected latency. The resource operation unit 620 may determine a candidate that generates MAEL among the candidate set in which the inference task and the processor available in the edge system are mapped, based on the calculated per-candidate score, and may assign an inference task, included in the determined candidate, to the processor included in the determined candidate. The resource operation unit 620 may sequentially accumulate scheduled tasks based on past schedule information according to a request priority queue present in the processor, and may insert the inference task between tasks pending in the request priority queue in a way to minimize average-expected latency.

For another example, the resource operation unit 620 may minimize the avoidance of SLO violation, and may configure the scheduling policy through SLO-aware-based MAEL in order to minimize the total sum of SLO violation levels as the SLO violation is expected to occur by taking system throughput into consideration. The resource operation unit 620 may collect a candidate set in which an inference task and a processor available in the edge system are mapped based on SLO requirements for each task, and may calculate a per-candidate score for the candidate set by repeating the process of collecting the collected candidate set. The resource operation unit 620 may calculate average-expected latency and a score for the SLO, may check whether an expected wait time is greater than a required SLO before calculating the score, may calculate SLO violation degrees instead of calculating the expected wait time because the task is expected to violate the SLO when the expected wait time is greater than the required SLO, and may accumulate negative values of the calculated degrees of SLO violation. The resource operation unit 620 may determine a candidate having a score having a preset reference or higher based on the calculated per-candidate score, and may assign an inference task, included in the determined candidate, to a processor included in the determined candidate.

For another example, the resource operation unit 620 may configure the scheduling policy through SLO-aware-based MAEL preemption using a model slicing scheme that achieves a preemption effect for a scheduling goal by splitting a large ML model into smaller, but evenly-sized sub-ML models by using the properties of the large ML model composed of a plurality of layers and filling sub-tasks for each split sub-ML model. The resource operation unit 620 may check whether model slicing is enabled or disabled, may split an inference task into a set of sliced sub-tasks while removing the inference task from a task set in order to prevent the calculation of redundant tasks when the model slicing is enabled, and may insert the sliced sub-task into the task set. If the slice mode has been disabled while the sliced sub-task is inserted into a request priority queue, the resource operation unit 620 may check whether a designated task is expected to violate SLO requirements due to a pending latency task, may enable the slice mode when the designated task is expected to violate the SLO requirements due to the pending latency task, and may disable the slice mode when the designated task is expected to not violate the SLO requirements due to the pending latency task. If the slice mode has already been enabled, the resource operation unit 620 may check whether sliced pieces of the slice mode help eliminating potential SLO violation, may maintain the slice mode in the enabled state if it is determined that the sliced pieces of the slice mode help eliminating the potential SLO violation, and may disable the slice mode if it is determined that the sliced pieces of the slice mode do not help eliminating the potential SLO violation.

The aforementioned device may be implemented as a hardware component, a software component and/or a combination of a hardware component and software component. For example, the device and component described in the embodiments may be implemented using a processor, a controller, an arithmetic logic unit (ALU), a digital signal processor, a microcomputer, a field programmable gate array (FPGA), a programmable logic unit (PLU), a microprocessor or one or more general-purpose computers or special-purpose computers, such as any other device capable of executing or responding to an instruction. The processing device may perform an operating system (OS) and one or more software applications executed on the OS. Furthermore, the processing device may access, store, manipulate, process and generate data in response to the execution of software. For convenience of understanding, one processing device has been illustrated as being used, but a person having ordinary skill in the art may understand that the processing device may include a plurality of processing elements and/or a plurality of types of processing elements. For example, the processing device may include a plurality of processors or a single processor and a single controller. Furthermore, a different processing configuration, such as a parallel processor, is also possible.

Software may include a computer program, a code, an instruction or a combination of one or more of them and may configure a processing device so that the processing device operates as desired or may instruct the processing devices independently or collectively. The software and/or the data may be embodied in any type of machine, a component, a physical device, virtual equipment, a computer storage medium or a device in order to be interpreted by the processor or to provide an instruction or data to the processing device. The software may be distributed to computer systems connected over a network and may be stored or executed in a distributed manner. The software and the data may be stored in one or more computer-readable recording media.

The method according to an embodiment may be implemented in the form of a program instruction executable by various computer means and stored in a computer-readable recording medium. The computer-readable recording medium may include a program instruction, a data file, and a data structure alone or in combination. The program instruction stored in the medium may be specially designed and constructed for an embodiment, or may be known and available to those skilled in the computer software field. Examples of the computer-readable medium include magnetic media such as a hard disk, a floppy disk and a magnetic tape, optical media such as a CD-ROM and a DVD, magneto-optical media such as a floptical disk, and hardware devices specially configured to store and execute a program instruction, such as a ROM, a RAM, and a flash memory. Examples of the program instruction include not only machine language code produced by a compiler, but a high-level language code which may be executed by a computer using an interpreter, etc.

As described above, although the embodiments have been described in connection with the limited embodiments and the drawings, those skilled in the art may modify and change the embodiments in various ways from the description. For example, proper results may be achieved although the aforementioned descriptions are performed in order different from that of the described method and/or the aforementioned elements, such as the system, configuration, device, and circuit, are coupled or combined in a form different from that of the described method or replaced or substituted with other elements or equivalents.

Accordingly, other implementations, other embodiments, and the equivalents of the claims fall within the scope of the claims.

The embodiments of the disclosure in which an exclusive property or privilege is claimed are defined as follows:

1. A scheduling method for a machine learning (ML) inference task, which is performed by a scheduling system, comprising:
receiving inference task requests of multiple ML models with respect to an edge system composed of heterogeneous processors; and
operating heterogeneous processor resources of the edge system based on a service-level objective (SLO)-aware-based scheduling policy in response to the received inference task requests.

2. The scheduling method of claim 1, wherein the SLO-aware-based scheduling policy comprises any one of a scheduling policy through minimum average-expected latency (MAEL), a scheduling policy through SLO-aware-based MAEL or a scheduling policy through SLO-aware-based MAEL preemption.

3. The scheduling method of claim 1, wherein operating the heterogeneous processor resources comprises configuring the scheduling policy through MAEL in order to minimize an average turnaround time of all the inference tasks requested and accumulated during a given scheduling time-window as latency for an inference task of an ML model expected at a scheduling point is predicted.

4. The scheduling method of claim 3, wherein operating the heterogeneous processor resources comprises:
collecting a candidate set in which a given inference task at a specific point in a runtime, which is periodically invoked, and a processor available in the edge system are mapped, and
calculating a per-candidate score for the candidate set by repeating a process of collecting the collected candidate set.

5. The scheduling method of claim 4, wherein operating the heterogeneous processor resources comprises:
estimating expected latency, which is a sum of latency of a profiled task in the available processor in order to calculate the per-candidate score and a current wait time attributable to a task whose scheduling is already pending, and
accumulating all the tasks in which the estimated expected latencies are set in an inverse order in order to designate priority of a candidate that provides minimum-expected latency.

6. The scheduling method of claim 4, wherein operating the heterogeneous processor resources comprises:
determining a candidate that generates MAEL among the candidate set in which the inference task and the processor available in the edge system are mapped based on the calculated per-candidate score, and
assigning an inference task, included in the determined candidate, to a processor included in the determined candidate.

7. The scheduling method of claim 4, wherein operating the heterogeneous processor resources comprises:
sequentially accumulating scheduled tasks based on past schedule information according to a request priority queue present in the processor, and
inserting the inference task between tasks pending in the request priority queue in a way to minimize average-expected latency.

8. The scheduling method of claim 1, wherein operating the heterogeneous processor resources comprises configuring a scheduling policy through SLO-aware-based MAEL in order to minimize a total sum of SLO violation levels as an SLO violation is expected to occur by taking system throughput into consideration after minimizing avoidance of the SLO violation.

9. The scheduling method of claim 8, wherein operating the heterogeneous processor resources comprises:
collecting a candidate set in which an inference task and a processor available in the edge system are mapped based on SLO requirements for each task, and
calculating a per-candidate score for the candidate set by repeating a process of collecting the collected candidate set.

10. The scheduling method of claim 9, wherein operating the heterogeneous processor resources comprises:
calculating average-expected latency and a score for the SLO,
checking whether the expected latency is greater than a required SLO before calculating the score,
calculating SLO violation degrees instead of calculating expected latency because the task is expected to violate the SLO when the expected latency is greater than the required SLO, and
accumulating negative values of the calculation SLO violation degrees.

11. The scheduling method of claim 9, wherein operating the heterogeneous processor resources comprises:
determining a candidate having a score having a preset reference or higher based on the calculated per-candidate score, and
assigning an inference task, included in the determined candidate, to a processor included in the determined candidate.

12. The scheduling method of claim 1, wherein operating the heterogeneous processor resources comprises configuring a scheduling policy through SLO-aware-based MAEL preemption using a model slicing scheme that achieves a preemption effect for a scheduling goal by splitting an ML model into evenly-sized sub-ML models by using properties of the ML model composed of a plurality of layers and achieving and filling sub-tasks for each split sub-ML model.

13. The scheduling method of claim 12, wherein operating the heterogeneous processor resources comprises:
checking whether model slicing is enabled or disabled,
splitting the inference task into a set of sliced sub-tasks while removing the inference task from the task set in order to prevent a calculation of redundant tasks when the model slicing is enabled, and
inserting the sliced sub-tasks into the task set.

14. The scheduling method of claim 13, wherein operating the heterogeneous processor resources comprises:
determining whether a designated task is expected to violate SLO requirements due to a pending latency task when a slice mode is disabled while inserting the sliced sub-tasks into the request priority queue,
enabling the slice mode when the designated task is expected to violate the SLO requirements due to the pending latency task, and
disabling the slice mode when the designated task is expected to not violate the SLO requirements due to the pending latency task.

15. The scheduling method of claim 14, wherein operating the heterogeneous processor resources comprises:
checking whether sliced pieces of the slice mode help eliminating potential SLO violations when the slice mode is already enabled,
maintaining the slice mode in the enable state when determining that the sliced pieces of the slice mode help eliminating the potential SLO violation, and
disabling the slice mode when determining that the sliced pieces of the slice mode do not help eliminating the potential SLO violation.

16. A computer program stored in a computer-readable recording medium in order to execute a scheduling method for a machine learning (ML) inference task, which is performed by a scheduling system, the scheduling method comprising:
receiving inference task requests of multiple ML models with respect to an edge system composed of heterogeneous processors; and
operating heterogeneous processor resources of the edge system based on a service-level objective (SLO)-aware-based scheduling policy in response to the received inference task requests.

17. A scheduling system comprising:
a task request reception unit configured to receive inference task requests of multiple ML models with respect to an edge system composed of heterogeneous processors; and
a resource operation unit configured to operate heterogeneous processor resources of the edge system based on a service-level objective (SLO)-aware-based scheduling policy in response to the received inference task requests.

18. The scheduling system of claim 17, wherein the resource operation unit configures the scheduling policy through MAEL in order to minimize an average turnaround time of all the inference tasks requested and accumulated during a given scheduling time-window as latency for an inference task of an ML model expected at a scheduling point is predicted.

19. The scheduling system of claim 17, wherein the resource operation unit configures a scheduling policy through SLO-aware-based MAEL in order to minimize a total sum of SLO violation levels as an SLO violation is expected to occur by taking system throughput into consideration after minimizing avoidance of the SLO violation.

20. The scheduling system of claim 17, wherein the resource operation unit configures a scheduling policy through SLO-aware-based MAEL preemption using a model slicing scheme that achieves a preemption effect for a scheduling goal by splitting an ML model into evenly-sized sub-ML models by using properties of the ML model composed of a plurality of layers and achieving and filling sub-tasks for each split sub-ML model.
